(19) United States
(12) Patent Application Publication
(10) Pub. No.: US 2011/0320239 A1
(43) Pub. Date: Dec. 29, 2011

(54) FAULT TOLERANT SOCIAL NETWORKS FOR SERVICE ORGANIZATIONS

(75) Inventors: Nithya Rajamani, Hyderabad (IN); Anupam Saronwala, New Delhi (IN)

(73) Assignee: INTERNATIONAL BUSINESS MACHINES CORPORATION, Armonk, NY (US)

(21) Appl. No.: 12/824,701

(22) Filed: Jun. 28, 2010

(51) Int. Cl. G06Q 10/00; G06F 11/07

(52) U.S. Cl. 705/7.26; 714/25; 714/E11.021; 705/7.11

(57) ABSTRACT

A social network of service provider and service recipient teams, which in turn is analyzed from a global perspective of the provider organization, that is, the representation and analysis and recommendations are internally driven by a service provider organization. Informal and formal relationships alike can be noted in the network representation. The nodes in the networks are team members from the provider and client organizations. The key decision makers in the client organizations are marked out in the graph. Each client node has an orientation which reflects whether the person has a positive orientation or negative orientation overall, globally and at a current point in time, towards the service provider organization. The client organization and the internal relationships can initially be assumed to be embodied by formal and functional relationships that are already well known and established, and yet can be adapted at later times.

### BACKGROUND

Generally, a key management and governance principle is to maintain right relationships with key decision making individuals. At the same time, it has been suggested that such contractual agreements at an organizational level lapse more into social relationships at individual level.

In management literature, it is well known that relationships play a key role in increasing client loyalty and hence revenue growth of a firm. However, continuing to manage the relationships has been mostly an informal and “soft” exercise that is done at the discretion of an individual and driven by appropriate incentives to drive beneficial interactions. The social interactions are also managed at an individual level rather than an organizational level, whereas maintaining service level agreements are discussed as “hard” factors in several formal and informal interactions at more global levels.

### BRIEF SUMMARY

In summary, one aspect of the invention provides a method comprising: representing supplier nodes in a network representation; representing client nodes in a network representation; establishing a supplier-client relationship in the network representation; assigning a score to the supplier-client relationship, the score corresponding to relationship strength; assigning a score to a client node, the client node score corresponding to a general relationship strength with respect to the supplier nodes in aggregate; and amending the supplier-client relationship score after a predetermined time period.

Another aspect of the invention provides an apparatus comprising: one or more processors; and a computer readable storage medium having computer readable program code embodied therewith and executable by the one or more processors, the computer readable program code comprising: computer readable program code configured to represent supplier nodes in a network representation; computer readable program code configured to represent client nodes in a network representation; computer readable program code configured to establish a supplier-client relationship in the network representation; computer readable program code configured to assign a score to the supplier-client relationship, the score corresponding to relationship strength; computer readable program code configured to assign a score to a client node, the client node score corresponding to a general relationship strength with respect to the supplier nodes in aggregate; and computer readable program code configured to amend the supplier-client relationship score after a predetermined time period.

An additional aspect of the invention provides a computer program product comprising: a computer readable storage medium having computer readable program code embodied therewith, the computer readable program code comprising: computer readable program code configured to represent client nodes in a network representation; computer readable program code configured to establish a supplier-client relationship in the network representation; computer readable program code configured to assign a score to the supplier-client relationship, the score corresponding to relationship strength; computer readable program code configured to assign a score to a client node, the client node score corresponding to a general relationship strength with respect to the supplier nodes in aggregate; and computer readable program code configured to amend the supplier-client relationship score after a predetermined time period.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a computer system.

FIG. 2 is a schematic representation of nodes in business to business relationships.

FIG. 3 is essentially the same view as FIG. 2 but showing supplier-client interaction.

FIG. 4 is essentially the same view as FIG. 3 but additionally showing client-client interaction.

FIG. 5 is essentially the same view as FIG. 4 but showing a variety of supplier-client and client-client interactions.

FIG. 6 sets forth a process more generally for FIG. 6 sets forth a process more generally for managing fault tolerant social networks.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments of the invention. One skilled in the relevant art will recognize, however, that the various embodiments of the invention can be practiced without one or more of the specific details, or with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

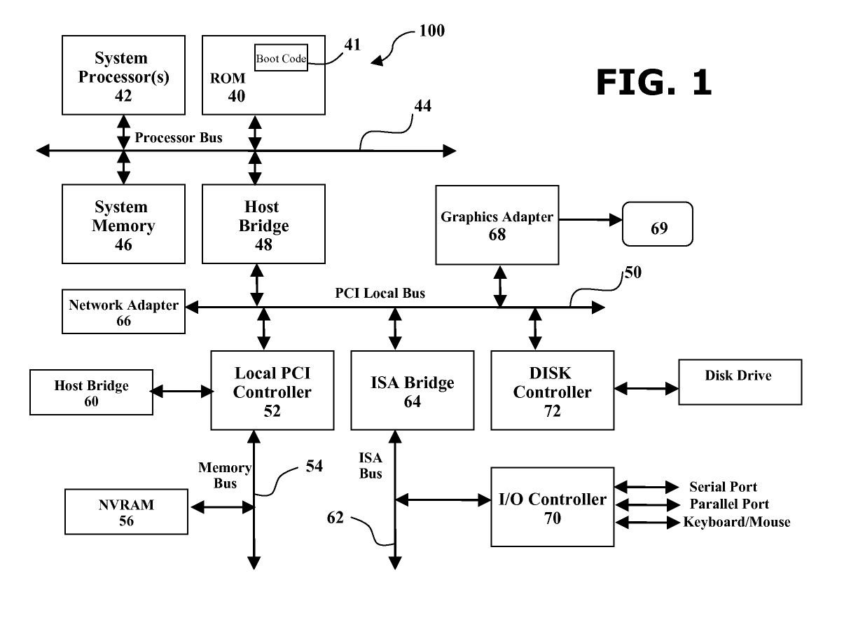

Referring now to FIG. 1, there is depicted a block diagram of an illustrative embodiment of a computer system 100. The illustrative embodiment depicted in FIG. 1 may be an electronic device such as a laptop or desktop personal computer, a mobile/smart phone or the like. As is apparent from the description, however, the embodiments of the invention may be implemented in any appropriately configured device, as described herein.

As shown in FIG. 1, computer system 100 includes at least one system processor 42, which is coupled to a Read-Only Memory (ROM) 40 and a system memory 46 by a processor bus 44. System processor 42, which may comprise one of the AMD line of processors produced by AMD Corporation or a processor produced by INTEL Corporation, is a general-purpose processor that executes boot code 41 stored within ROM 40 at power-on and thereafter processes data under the control of an operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 100 to LAN, and graphics adapter 68, which interfaces computer system 100 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 100 further includes Industry Standard Architecture (ISA) bus 62, which is coupled to PCI local bus 50 by ISA bridge 64. Coupled to ISA bus 62 is an input/output (I/O) controller 70, which controls communication between computer system 100 and attached peripheral devices such as a as a keyboard, mouse, serial and parallel ports, et cetera. A disk controller 72 connects a disk drive with PCI local bus 50. The USB Bus and USB Controller (not shown) are part of the Local PCI controller (52).

Broadly contemplated herein, in accordance with at embodiments of the invention, is a manner of representing client and service provider organizations as a social network and institutionalizing the relationships and interactions that are carried out in the relationship management through the network. The network is marked with key decision makers on the client side. The analysis that gets carried out over the network of relationships indicates the overall “reach” to key decision makers, the strength of the reach and a current orientation of each client node (positive or negative).

In accordance with embodiments of the invention, the network is populated individually by a service delivery team, by recording their relationship interactions on a regular basis with client side management at a peer level and above. The details of the interaction are anonymized outside of an individual's access, so privacy is maintained. A global analysis reports whether each relationship with a key decision maker is fault-tolerant overall, wherein there are multiple channels in client organization being leveraged by service provider to influence the key decision maker perceptions. Analyses at individual levels can suggest how individuals can improve their reach to key decision makers (e.g., via suggesting alternative paths through individuals in the client organization who have been reported to have a net positive orientation). Apart from the reach, the analysis can also suggest the weaker spots in the client organization where positive efforts need to be made to enable over-recovery of service failure. For example, consider a situation where client x is involved in a service interaction with supplier y and though the delivery is done well in the end, there were some unexpected failures and delays in execution of the service due to which the perception of client x (e.g., at the level of Executive Director) might not be an ideal one with respect to the provider. In that context, assume as well that there was another favorable effort executed in connection with a client z in the same organization (e.g., IT department manager). It should thus be appreciated that if z (or someone in the command line chain of y) communicates this favorable impression of y to x, whether formally or informally, perception of the client x can be enhanced overall even if client x does not have a need to know.

It will be appreciated herein that a tool in accordance with embodiments of the invention, and analysis employed in connection therewith, can be helpful to guide a team that is geographically disperse while also assisting new team members in understanding relationship dynamics. The tool is also helpful to assess the impact of a governance change in a client organization.

In accordance with embodiments of the invention, a social network of service provider and service recipient teams is developed, and this network is analyzed from a global perspective of the provider organization, that is, the representation and analysis and recommendations are internally driven by a service provider organization. Informal and formal relationships alike can be noted in the network representation. The nodes in the networks are team members from the provider and client organizations. The key decision makers in the client organizations are marked out in the graph. Each of the client nodes (node where client team members are represented), has an orientation which reflects whether the person has a positive orientation or negative orientation overall, globally and at a current point in time, towards the service provider organization. The client organization and the internal relationships can initially be assumed to be embodied by formal and functional relationships that are already well known and established, and yet can be adapted at later times based on further learning and input.

In accordance with embodiments of the invention, each service provider member updates on a regular basis (e.g., weekly), their interactions with client individuals at peer and higher levels and updates on the strength of interactions and how much of a positive or negative outcome resulted from it (e.g., on a scale of 0 to 10). The actual details from an individual perspective need not be revealed to anyone apart from the individual constructing it; instead, what becomes exposed globally is the aggregate orientations, connection paths in the network and the strength of the connections, where permitted by individual supplier nodes.

In accordance with embodiments of the invention, each client node is updated at regular intervals even if there are no obtained in connection with relationships that are affected through any particular incidents. This is so that at a global level actions can be taken to over-recover from, or compensate for, the situations in a subtle manner when they happen, and even when they don't, the overall network updates the orientations based on the history and any new events. At an individual level, each provider member gets an update on how much of coverage they have with the key decision makers and channels they can leverage to improve their coverage. At global level, the relationship owner gets a picture on the complete coverage with key individuals (e.g., executives) and whether it is fault-tolerant (e.g., survives losing a single breakage in a relationship). It also shows areas of concern globally (e.g., individuals on the client side having a net negative orientation) which needs to be corrected through service recovery strategies. All of this takes place, in accordance with embodiments of the invention, while maintaining individual network strengths in privacy.

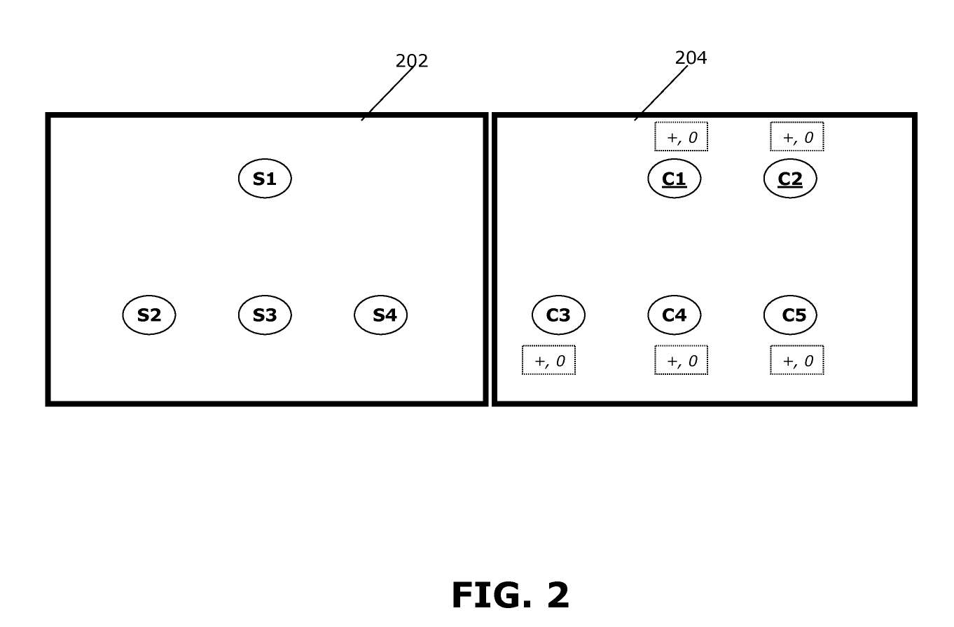

The disclosure now turns to FIGS. 2-5. It should be appreciated that the processes, arrangements and products broadly illustrated therein can be carried out on or in accordance with essentially any suitable computer system or set of computer systems, which may, by way of an illustrative and non-restrictive example, include a system such as that indicated at 100 in FIG. 1. In accordance with an example embodiment, most if not all of the process steps, components and outputs discussed with respect to FIGS. 2-5 (apart from external components such as mobile station wireless devices) can be performed or utilized by way of system processors and system memory such as those indicated, respectively, at 42 and 46 in FIG. 1, whether on a server computer, a client computer, a node computer in a distributed network, or any combination thereof.

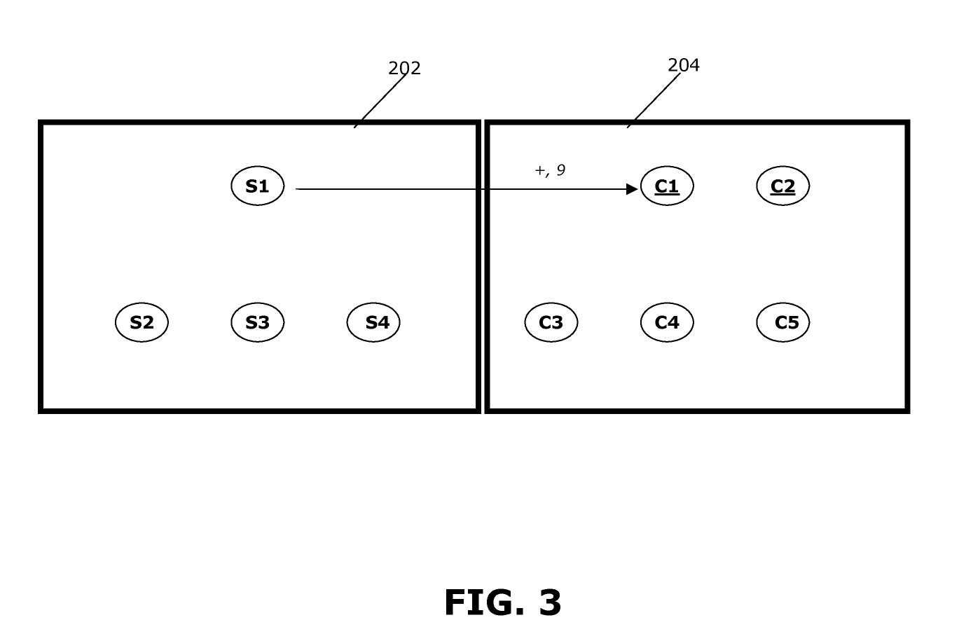

FIG. 2 is a schematic representation of nodes in business to business relationships, in accordance with at least one embodiment of the invention. As shown, the network representation includes a supplier side 202, with supplier nodes S1-S4, and a client side 204, with client nodes C1-C5. The number of nodes shown in here and FIGS. 3-5 is merely by way of illustrative example. Hierarchy may be represented by marking one or more nodes differently; in the present example, “key” or higher-up decision makers in a client organization are underlined (C1 and C2). Such relative hierarchical positioning of course can be updated at any time. In accordance with embodiments of the invention, there is appended to each client node on the client side 204 a global net orientation as represented inside the boxes with dotted lines. Each global net orientation has a “+” or “−” (positive or negative) sign followed by a number. In accordance with embodiments of the invention, the number may be from 0 to 10. The use and significance of the global net orientations will be more fully appreciated here below. FIG. 2 portrays an initial state or condition in which zero values are appended to each client node and which can be changed over time; based on any of a variety of pertinent factors (e.g., prior knowledge or experience), however, it is of course possible to append initial values other than zero in an initial state or condition of the network representation.

FIG. 3 is essentially the same view as FIG. 2 but showing supplier-client interaction, in accordance with at least one embodiment of the invention. Particularly, an interaction between S1 and C1 is shown.

Interactions can be marked on transactional or cumulative basis (i.e., what can be shown is each interaction between the nodes or, alternatively or in addition, cumulative interactions between nodes). To maintain scalability, when the volume of interactions is extremely high, cumulative ones can be leveraged for the analysis (e.g. only cumulative perceptions can be updated on a periodic basis such as bi-weekly containing frequency, type of interactions [work/social etc.], or alternatively transactional ones can be tracked and rolled into a cumulative one automatically periodically)

Assume, as shown in FIG. 2, that S1 interacts with C2 and ascertains that the orientation of C1 on the interaction was positive and rated 9 on 0 to 10 scale (relationship strength); this is shown in the drawing with “+, 9”. S1, as such, may log into a portal/tool where he or she can choose to see the network at any of a variety of scales, e.g., to see the whole network, nodes, interactions between nodes and global aspects of the metrics of the network, or any combination of these. S1 then updates the information, e.g., by creating a directional arrow between his/her own S1 node if it doesn't yet exist and then, either way, updates (creates a directional arrow between S1 node and C1 or if it exists, updates that with the new relationship strength). In accordance with embodiments of the invention, the tool ensures that only S1 can update for S1 in this manner. Similar changes to the network representation can be undertaken by all supplier nodes individually and independently of each other, with provisions for privacy protection.

In accordance with embodiments of the invention, a scenario can also be enabled where supervisors can record the interactions for their subjects and the tool develops consensus relationship strength (with any desired degree of privacy). The consensus relationship strength can be determined in essentially any manner deemed suitable, such as unweighted average between relationship scores or via weighted scores from each contributor that are then averaged.

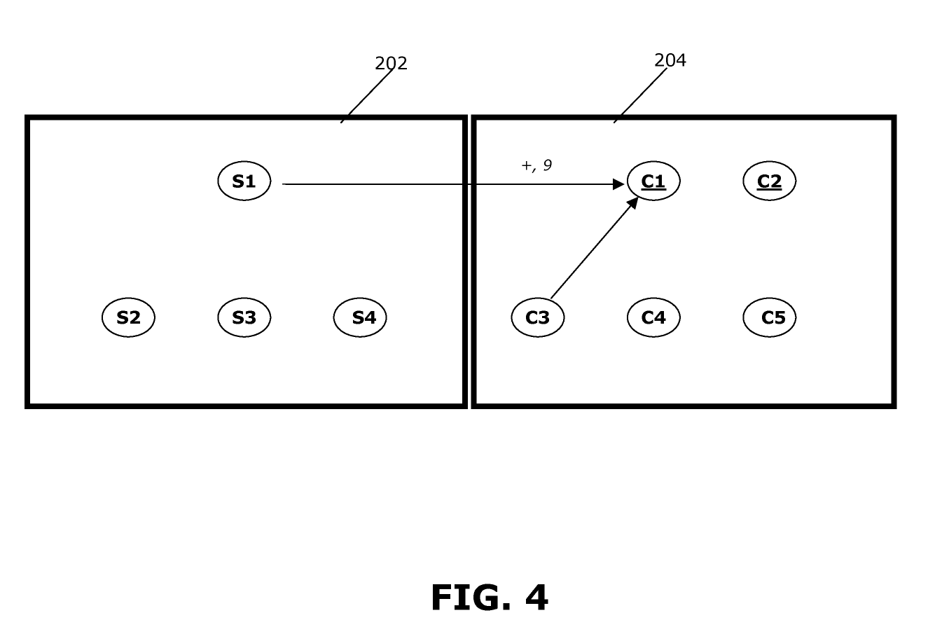

FIG. 4 is essentially the same view as FIG. 3 but additionally showing client-client interaction, in accordance with at least one embodiment of the invention. Particularly, an interaction between C4 and C2 is shown.

Generally, in accordance with embodiments of the invention, interactions between client nodes need not necessarily have any relationship strengths appended to them; for instance, such information could be very private and hard to obtain. However, the mere existence of interaction channels between client nodes can still be shown, as quite often this is common knowledge (in terms of hierarchical work relationships and who normally is in a position to talk to whom). Thus, an indication of the existence of interaction channels between client nodes can be established or updated by predetermined individuals/nodes on the supplier side 202 based on their own learning and experience. At the client end 204, when a portal/tool is exposed or availed to a client node, the client nodes can also update information about interactions at their end; as touched on before, the client nodes can also contribute to information on supplier-client interactions, e.g., by contributing to a consensus relationship strength score or establishing that value outright at the outset (subject to change at later times).

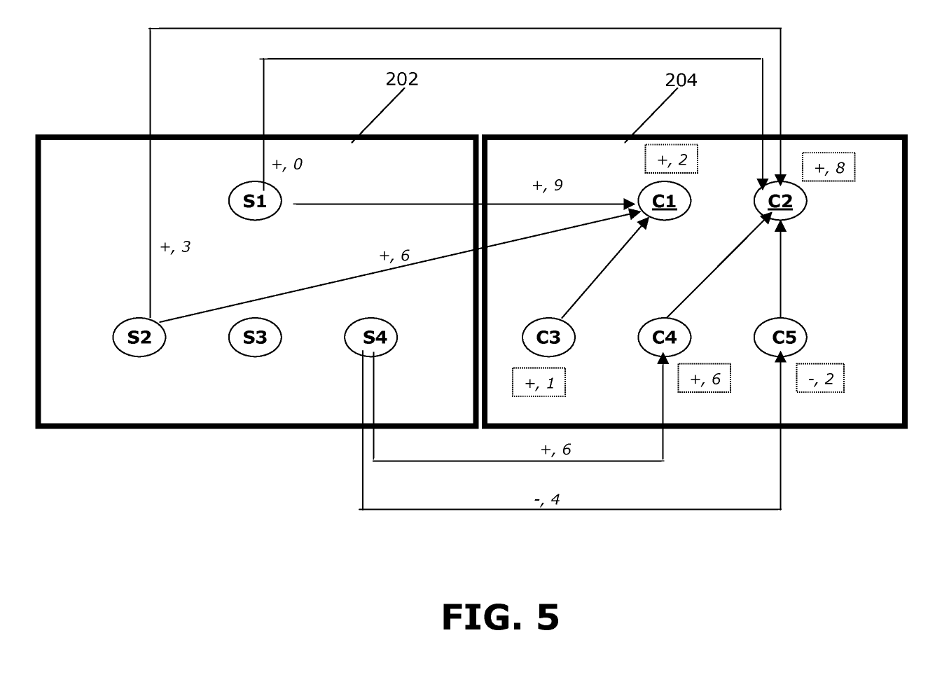

FIG. 5 is essentially the same view as FIG. 4 but showing a variety of supplier-client and client-client interactions, in accordance with at least one embodiment of the invention. The example of FIG. 5 will help provide an even better appreciation of the functioning of a network representation in accordance with embodiments of the invention and of its attendant features and advantages. To the extent that algorithms and formulas are discussed herebelow with reference to FIG. 5, it should be understood and appreciated that these algorithms and formulas are provided merely by way of illustrative and non-restrictive examples, and that other algorithms and formulas of course are conceivable within the scope of embodiments of the invention.

Assume that, for a given time period, the network snapshot appears as in FIG. 5. An individual provider fault tolerance metric is the existence of more than one channel from an individual supplier node to key decision client nodes (C1, C2) that has a positive net orientation and where the intersection of paths between the channels for any decision client node is nil.

“Intersection”, as understood in the context of at least one embodiment of the invention, refers to coinciding paths with respect to node pairs. For instance, if an indirect connection between C1 and C3 involves direct connections between C1-C2 and C2-C3, and an indirect connection between C1 and C4 involves direct connections between C1-C2 and C2-C4, then the paths can be said to intersect in the path C1-C2.

In accordance with embodiments of the invention, an individual provider coverage metric is the existence of at least one channel from an individual supplier node to key decision client nodes that has a positive net orientation. Coverage is subsumed by a fault tolerance metric, particularly, “no coverage” corresponds to “no fault tolerance”, while “fault tolerance” corresponds to “coverage exists”. In other words, for instance, if there is a fault tolerant relationship between Cx and Cy, then Cy is certainly covered by Cx.

Referring to the example of FIG. 5, assume that S4 has no coverage with C1 and S4 (indirectly, via two different paths through C4 and C5) has coverage with C2. From this, it is ascertained that S4 has coverage of 50%, in that it has a connection with one “key” client node and not the other. It thus can be determined that S4 clearly has no fault tolerant paths to C1 and, assuming a simple additive model, it has 2 net positive channels with no intersecting paths (S4-C4, C4-C2 & S4-C5, C5-C2 with scores of 14 (C4 global orientation+C2 global orientation) and 6 (C5 global orientation+C2 global orientation)). Fault tolerance is also at 50%.

In accordance with embodiments of the invention, a global provider fault tolerance metric is the existence of more than one channel from more than one individual supplier node to key decision client nodes that has a positive net orientation and where the intersection of paths between the channels for any particular supplier-decision (key) client node is nil. (It should be understood that the terms “key” client node and “decision” client node may be considered herein to be interchangeable.)

The global provider fault tolerance metric can be made more stringent by defining that at least “n” supplier nodes must have net positive channels to each decision node and within those at least “x” supplier node paths should produce a nil intersection between each other for a specific decision node. It will be appreciated that in this context n must at a minimum be 2 and x could be 1. At an abstract level, it can be represented as fault tolerant@(n,x).

In accordance with embodiments of the invention, a global provider coverage metric is the existence of at least one channel from any supplier node to key decision client nodes (C1, C2 here) that has a positive net orientation. Even one individual coverage in this context would imply that the global coverage for the network for that decision node in question exists.

In the example of FIG. 5, the global fault tolerance of the supplier network for C1 is 100%, (S1-C1, S2-C1) @ (2,2). For C2 it is 100%, (S1-C2, S2-C2, S4-C4-C2, S4-C5-C2) @ (3, 3). Thus, global coverage is 100% for C1 and C2

In accordance with embodiments of the invention, global net orientation is calculated at each time-period “t” (e.g., bi-weekly) for each client node and in general for the client network 204 (i.e., its orientation or perspective towards the entire supplier network 202) as follows:

GNO(t) for Cx=(GNO(t−1) for Cx+where there exists Sa->Cx (Σ(hierarchy importance of supplier node Sa*strength of link from Sa to that Cx))/num such S->Cx links+where exists Cx->Cy (Σ(hierarchy of importance of Cy*GNO(t−1) for Cy))/num such Cx->C links+where exists a structural hole filled by Sb between Cz, Cx (Σ(social capital worth between Cz, Cx*strength of link between Sb and Cz))/num such structural holes)/4.

Here, Cx is a historical score form the last period, “Cx links” indicates direct links between any supplier node and the client node in question and the effect of that in the current orientation. “C links” indicates the existence of direct communication between other client nodes and the client node in question, their prior orientations and how that affects the client node in question. “Social capital worth” or “social worth” relates to how, e.g., Sb talks to Cz and Cx, but Cz and Cx do not talk between themselves. Thus, Sb can affect the perceptions of both clients by filling the “structural hole” or “social hole” between them. The “social worth” or “social capital worth” numerical value, as discussed and contemplated herein, can be a number from 0 to 1, with a higher value corresponding to a greater degree of social (capital) worth as just discussed; this can be determined in view of any suitable criteria. Finally, dividing by 4 here encompasses taking an average.

Hierarchy importance can be between 0 and 1 (i.e., the reciprocal of a numerical level of hierarchy; the hierarchy level, e.g., could be a number from 1 to n with a lower number conveying more importance) and social worth between 0 and 1 (it can be decided based on hierarchy levels or other factors). Thus, GNO should fall between 0 and 10. In accordance with example embodiments of the invention, to start with GNO(0) is set to be 0 for all client nodes

By way of example, GNO(t−1) is represented by values in the dotted boxes in the drawings, while GNO(t) can be calculated in a manner as follows.

Thus, GNO(t) for C5=(−2+(1/3*−4)+(1*8)+(social worth(C4−C5)*6)/4=(−2−4/3+8+0.1*6)/4=+1.3

Also, in embodiments of the invention, GNO(t) employs weights to decide on the relative importance of past experience, current experience, influence from rest of the ecosystem (cognitive dissonance theory), influence of social capital (social capital theory). The weights can be estimated based on correlating the network strengths with the overall satisfaction results obtained during annual or other surveys. In the example of FIG. 5, the overall global net orientation of client C at time t−1=(2+8+1+6−2)/5=3 (simple additive or could be alternative using hierarchy etc.).

By way of accommodating changes in the client network 204, consider if Cx leaves. If it has a large negative orientation, the impact on supplier network 202 is not large, whereas if it has a large positive orientation, it would leave the system weaker in terms of relationship orientation strength

In the example of FIG. 5, if C5 leaves the network then there is virtually no adverse impact. However, if C4 leaves, then a positive supporter is clearly leaving and thus adversely impacts overall GNO, which decreases to 1.8 from 3. Also consider the influence on other negative oriented peers (cognitive dissonance factor); in other words, based on cognitive dissonance and social capital theories as mentioned above and as commonly known, one can be influenced significantly by perceptions of peers and higher-ups. This can well have an effect on GNO. Broadly, in accordance with embodiments of the invention, GNO can be influenced by historical relationship considerations, current relationship considerations, cognitive dissonance considerations and social capital considerations.

If C5 leaves, the coverage and fault tolerance would still be different. S4 would still have coverage of 50% (through C4), while S4's fault tolerance becomes 0% from 50% before. Thus, S4 would then require a way to establish another path to C2; since no direct path would exist, at least a path could be established to C1 through C3 that has a net positive perspective.

It should be appreciated that changes as outlined above do affect global versions of coverage and fault tolerance metrics. Particularly, S1 would be in a position to make global decisions based on the state of the relationship to do proactive relationship management, while each Sx would be in a position to make decisions for its own interactions to maintain its relationship strengths.

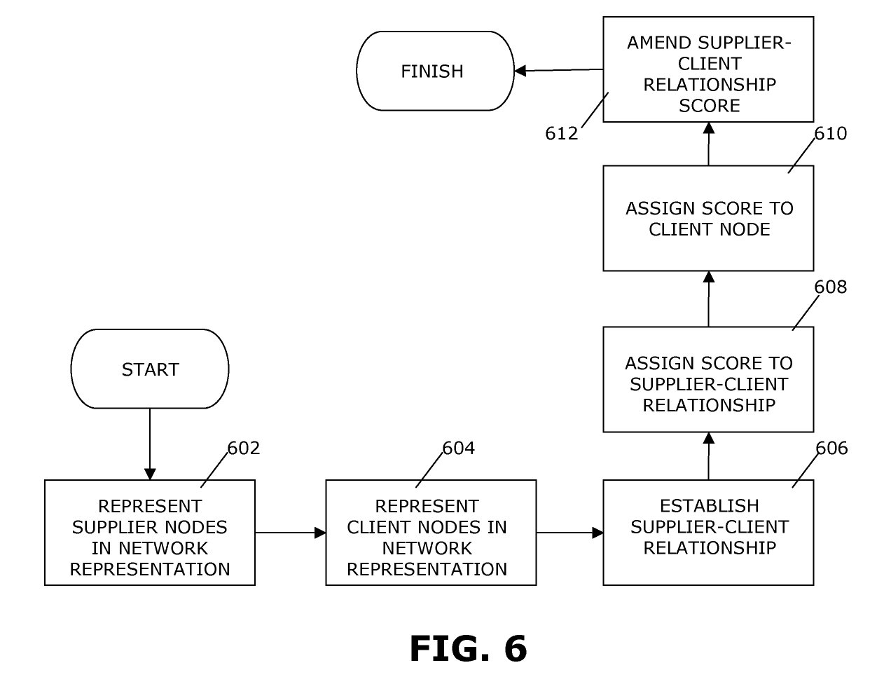

FIG. 6 sets forth a process more generally for managing fault tolerant social networks in accordance with at least one embodiment of the invention. It should be appreciated that a process such as that broadly illustrated in FIG. 6 can be carried out on essentially any suitable computer system or set of computer systems, which may, by way of an illustrative and on-restrictive example, include a system such as that indicated at 100 in FIG. 1. In accordance with an example embodiment, most if not all of the process steps discussed with respect to FIG. 6 can be performed by way of system processors and system memory such as those indicated, respectively, at 42 and 46 in FIG. 1.

As shown in FIG. 6, supplier nodes (602) and client nodes (604), respectively, are represented in a network representation A supplier-client relationship is established (606) and a score is assigned to the same (608), corresponding to relationship strength. A score is assigned to a client node (610), the client node score corresponding to a general relationship strength with respect to the supplier nodes in aggregate. The supplier-client relationship score is amended after a predetermined time period (612).

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method comprising:
representing supplier nodes in a network representation;
representing client nodes in a network representation;
establishing a supplier-client relationship in the network representation;
assigning a score to the supplier-client relationship, the score corresponding to relationship strength;
assigning a score to a client node, the client node score corresponding to a general relationship strength with respect to the supplier nodes in aggregate; and
amending the supplier-client relationship score after a predetermined time period.

2. The method according to claim 1, wherein said representing of client nodes comprises representing key client nodes.

3. The method according to claim 2, wherein said representing of key client nodes comprises representing nodes corresponding to a higher hierarchy level than other client nodes in a client organization.

4. The method according to claim 2, further comprising applying a coverage metric to a supplier node with respect to a relationship of the supplier node to key client nodes in aggregate.

5. The method according to claim 4, wherein the coverage metric represents the proportion of key client nodes with which a supplier node has an established direct or indirect relationship.

6. The method according to claim 2, further comprising applying a coverage metric to the supplier nodes in aggregate with respect to a relationship of the supplier nodes to key client nodes in aggregate.

7. The method according to claim 1, wherein said assigning of a score to the supplier-client relationship further comprises appending a positive or negative orientation to the score of the supplier-client relationship.

8. The method according to claim 7, wherein said assigning of a score to a client node comprises appending a positive or negative orientation to the score of the client node.

9. The method according to claim 1, wherein said amending is performed among supplier nodes solely by the supplier node in the supplier-client relationship.

10. The method according to claim 9, wherein said amending is further performed by a client node in the supplier-client relationship.

11. The method according to claim 1, further comprising determining a fault tolerance metric for a supplier node with respect to one or more client nodes.

12. The method according to claim 1, further comprising determining a fault tolerance metric for the supplier nodes in aggregate with respect to one or more client nodes.

13. An apparatus comprising:
one or more processors; and
a computer readable storage medium having computer readable program code embodied therewith and executable by the one or more processors, the computer readable program code comprising:
computer readable program code configured to represent supplier nodes in a network representation;
computer readable program code configured to represent client nodes in a network representation;
computer readable program code configured to establish a supplier-client relationship in the network representation;
computer readable program code configured to assign a score to the supplier-client relationship, the score corresponding to relationship strength;
computer readable program code configured to assign a score to a client node, the client node score corresponding to a general relationship strength with respect to the supplier nodes in aggregate; and
computer readable program code configured to amend the supplier-client relationship score after a predetermined time period.

14. A computer program product comprising:
a computer readable storage medium having computer readable program code embodied therewith, the computer readable program code comprising:
computer readable program code configured to represent client nodes in a network representation;
computer readable program code configured to establish a supplier-client relationship in the network representation;
computer readable program code configured to assign a score to the supplier-client relationship, the score corresponding to relationship strength;
computer readable program code configured to assign a score to a client node, the client node score corresponding to a general relationship strength with respect to the supplier nodes in aggregate; and
computer readable program code configured to amend the supplier-client relationship score after a predetermined time period.

15. The computer program product according to claim 14, wherein said computer readable program code is configured to represent key client nodes among the client nodes.

16. The computer program product according to claim 15, wherein said computer readable program code is configured to represent key client nodes which correspond to a higher hierarchy level than other client nodes in a client organization.

17. The computer program product according to claim 15, wherein said computer readable program code is further configured to apply a coverage metric to a supplier node with respect to relationship of the supplier node to key client nodes in aggregate.

18. The computer program product according to claim 17, wherein the coverage metric represents the proportion of key client nodes with which a supplier node has an established direct or indirect relationship.

19. The computer program product according to claim 15, wherein said computer readable program code is further configured to apply a coverage metric to the supplier nodes in aggregate with respect to a relationship of the supplier nodes to key client nodes in aggregate.

20. The computer program product according to claim 14, wherein said computer readable program code is further configured to append a positive or negative orientation to the score of the supplier-client relationship.

21. The computer program product according to claim 20, wherein said computer readable program code is further configured to append a positive or negative orientation to the score of the client node.

22. The computer program product according to claim 14, wherein said computer readable program code is configured to permit amending among supplier nodes solely by the supplier node in the supplier-client relationship.

23. The computer program product according to claim 22, wherein said computer readable program code is further configured to permit amending by a client node in the supplier-client relationship.

24. The computer program product according to claim 14, wherein said computer readable program code is further configured to determine a fault tolerance metric for a supplier node with respect to one or more client nodes.

25. The computer program product according to claim 14, wherein said computer readable program code is further configured to determine a fault tolerance metric for the supplier nodes in aggregate with respect to one or more client nodes.
